(19) United States
(12) Patent Application Publication
(10) Pub. No.: US 2014/0076075 A1
(43) Pub. Date: Mar. 20, 2014

(54) Spiral Gear System

(71) Applicant: Bowboard, LLC, Belleair, FL (US)

(72) Inventor: Christopher Phillip Miller, Clearwater, FL (US)

(73) Assignee: Bowboard, LLC, Belleair, FL (US)

(21) Appl. No.: 14/026,036

(22) Filed: Sep. 13, 2013

Related U.S. Application Data
(60) Provisional application No. 61/701,279, filed on Sep. 14, 2012.

(51) Int. Cl. F16H 25/14

(52) U.S. Cl. CPC F16H 25/14
USPC 74/55

(57) ABSTRACT

A spiral gear converts reciprocating motion into rotational motion or rotational motion into reciprocating motion. An interface travels along a spiral such that, as the interface is displaced in a first linear direction, the spiral is caused to rotate clockwise, and as the interface is displaced in a second, opposite linear direction, the spiral is cause to rotate in a counterclockwise direction.

### CROSS-REFERENCE TO RELATED APPLICATION

This application takes priority from provisional application 61/701,279, filed Sep. 14, 2012, inventor Christopher Phillip Miller.

This application is related to U.S. patent application Ser. No. 13/156,910, filed Jun. 9, 2011 and inventors Gregory R. Prior and Christopher Phillip Miller; which is a continuation of U.S. Pat. No. 7,980,578, issued Jul. 19, 2011, inventors Gregory R. Prior and Christopher Phillip Miller; which takes priority from U.S. provisional patent application Ser. No. 60/918,058, filed Mar. 15, 2007, the disclosure of all are hereby incorporated by reference.

### FIELD OF THE INVENTION

This invention relates to a method and apparatus for translating reciprocating energy into rotational energy, as for example used in a device of human conveyance to propel the device in a controlled manner along a navigable path.

### BACKGROUND OF THE INVENTION

When a person jumps in the air using muscle energy a substantial amount of potential energy has been created. An example would be appreciated by watching as the person springs and bounce higher and higher on a diving board. Similarly, a human can simply lift one foot off the ground, while maintaining support with the other foot. Thereafter, with gravity alone or with a slight amount of additional downward muscle force, the human may allow the elevated foot's weight to descend and create a comparable effect.

Humanly created potential energy is available to be converted into a substantial amount of useful kinetic energy through little additional effort, by only relying on the natural laws of gravity.

Prior devices for human conveyance relied upon this kinetic energy to be directed onto a pedal system as in a bicycle or pushed against the ground as with a scooter or skateboard. In this, the user is required to provide energy in a rotational fashion by, for example, moving bike pedals in a generally circular pattern. Being that it is not practical to integrate a pedal system in a scooter or a skate board because of the low clearance of the running board of such devices, a way to propel such a device using the energy of a human user is needed.

Devices disclose in U.S. patent application Ser. No. 13/156,910, filed Jun. 9, 2011 and inventors Gregory R. Prior and Christopher Phillip Miller as well as U.S. Pat. No. 7,980,578 to the same show how a spring system is used to propel a device for human conveyance such as a scooter. The disclosed system functions properly using a sprocket or gear to act as a rack and pinion to convert the substantially linear movement of the tail of the spring device into a rotational moment to propel the rear wheel.

It is known that springs of various spring systems often do not exert a linear force or resistance along the full extension/compression of the spring. For example, when compressing a 2″ compression spring, less force is required to compress a first ½″ while more force is required to compress the second ½″, etc.

An arc-shaped spring as in some embodiments of the above noted references exhibits non-linear force curves as well. When the spring starts in its natural arc shape, more force is required to begin to flatten the spring, then as the spring approaches the flattened configuration, less force is need to continue to flatten the arc-shaped spring. In applications in which a person stands on such a spring, the downward force is substantially linear being that the mass of the user is constant. At the beginning of travel, the force of the person will bend the spring at a certain rate. Since the downward force is constant, the downward force will bend the same spring at a faster rate as the spring approaches a flat configuration. This will cause an undesirable bottoming out of the spring.

When used in a device of human conveyance, it is preferred, though not required, to better utilize the full length of travel of such an arc-shaped spring. It is also preferred that a constant velocity be achieved as the user flattens the spring or even possibly a higher velocity to start, then slowing as the arc-shaped spring begins to flatten, providing a dampening feel to the user.

Many other situations are conceived in which a reciprocating or somewhat linear motion needs to be translated into rotational motion as is needed to convert the reciprocating motion of a piston into the rotational motion of a crankshaft, etc. In some situations, it is also desired to change ratios of motion such that a certain linear movement (e.g. a certain number of centimeters) is translated into a certain rotational movement (e.g. a certain number of degrees of rotation), at the same time, translating the force in, for example, foot-pounds.

What is needed is a system that converts somewhat linear motion into rotational motion.

### SUMMARY OF THE INVENTION

A spiral gear converts reciprocating motion into rotational motion or rotational motion into reciprocating motion. An interface travels along a spiral such that, as the interface is displaced in a first linear direction, the spiral is caused to rotate clockwise, and as the interface is displaced in a second, opposite linear direction, the spiral is cause to rotate in a counterclockwise direction.

In one embodiment, a spiral gear system is disclosed including a source of reciprocating motion. A spiral is rotatably held to enable rotation of the spiral. An interface couples the source of reciprocating motion to the spiral such that motion of the source of reciprocating motion in a first direction causes the interface to traverse the spiral in one direction and, therefore, causes the spiral to rotate in a first rotational direction. Motion of the source of reciprocating motion in a second direction, opposite to the first direction, causes the interface to traverse the spiral in a direction opposite of the one direction and, therefore, causes the spiral to rotate in a second rotational direction opposite of the first rotational direction.

In another embodiment, a spiral gear system is disclosed including an interface for receiving reciprocating motion. A disc is mounted to a rotatable shaft by a one-way bearing and there is a spiral groove in the disc, the spiral groove having a width suitable for slideably holding the interface such that the interface will move along the spiral groove. Linear movement of the interface in a first direction causes the interface to traverse the spiral groove in one direction and, therefore, causes the spiral groove, disc, and shaft to rotate in a first rotational direction. Linear movement of the interface in a second direction, opposite to the first direction, causes the interface to traverse the spiral in a direction opposite of the one direction and, therefore, causes the spiral groove and disc to rotate in a second rotational direction opposite of the first rotational direction.

In another embodiment, a method of converting reciprocating movement into rotational movement is disclosed. The method includes providing a source of reciprocating motion and providing a spiral that is rotatably held to enable rotation of the spiral. The source of reciprocating motion is coupled to the spiral through an interface. The interface is coupled to the spiral such that the interface freely traverses the spiral. As the source of reciprocating motion moves the interface in a first direction, the interface is forced to traverse the spiral in one direction and, therefore, the spiral rotates in a first rotational direction. As the source of reciprocating motion moves the interface in a second direction, opposite to the first direction, the interface is forced to traverse the spiral in a direction opposite of the prior direction and, therefore, the spiral rotates in a second rotational direction opposite of the first rotational direction.

### BRIEF DESCRIPTION OF THE DRAWINGS

The invention can be best understood by those having ordinary skill in the art by reference to the following detailed description when considered in conjunction with the accompanying drawings in which:

FIG. 1A illustrates a schematic view of a spiral gearing system in an initial position in which the pin is at a first position within the spiral.

FIG. 1B illustrates a schematic view of a spiral gearing system in an initial position in which the pin is at a second position within the spiral.

FIG. 1C illustrates a schematic view of a spiral gearing system in an initial position in which the pin is at a third position within the spiral.

FIG. 2 illustrates a schematic view of a spiral gearing system showing distances traveled through several position of the pin within the spiral.

FIG. 3 illustrates a schematic view of a spiral gearing system showing changes in the gearing ratio caused by changes in force angle.

FIG. 4 illustrates an operational schematic view of an example of a spiral gearing system in an initial position in which the spring is in the relaxed configuration.

FIG. 5 illustrates an operational schematic view of an example of a spiral gearing system in an intermediate position in which the spring is in a partially bent configuration.

FIG. 6 illustrates an operational schematic view of an example of a spiral gearing system in an fully compressed position in which the spring is in the fully flattened configuration.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

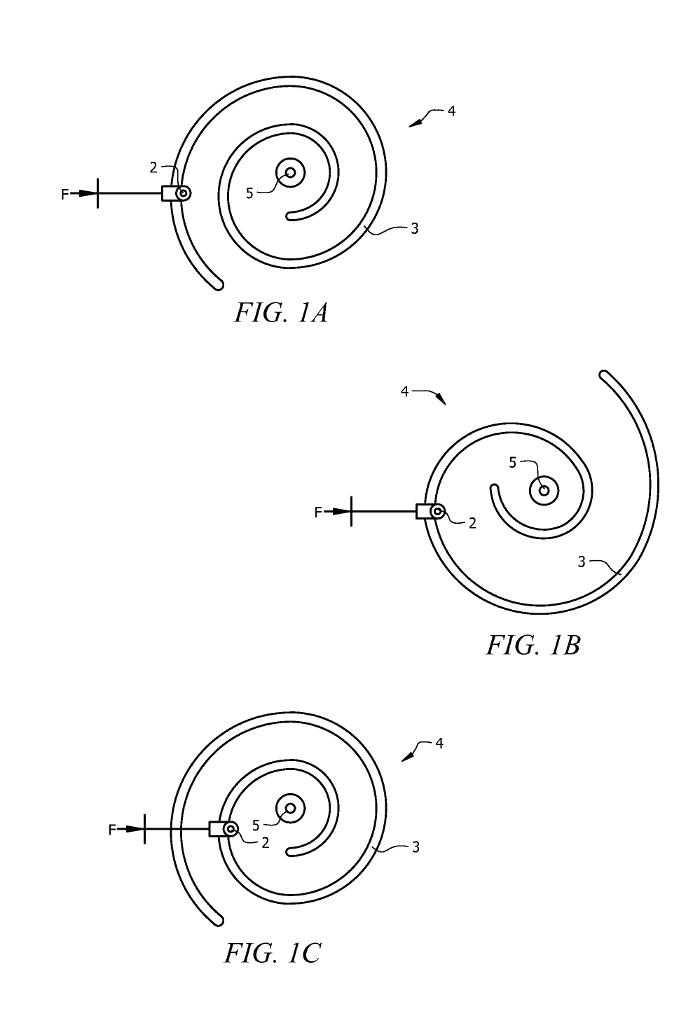

Referring to FIGS. 1A, 1B, and 1C, schematic views of a spiral gearing system 4 are shown in progressive positions of the pin 2 within/along the spiral 3.

In general, the spiral 3 rotates around a pivot 5 or within a confined space. Any type of pivot 5 or rotatable coupling is anticipated, including a pin, an axle, a bearing, and axle/bearing combination, a non-pivot (e.g., the spiral is rotatably housed within a channel), etc.

In some embodiments, the pivot 5 is interfaced with a ratchet mechanism to convert alternating clockwise and counter clockwise rotation of the spiral 3 into either clockwise or counterclockwise rotation of a central shaft or other coupled device (not shown).

The spiral 3 is slideably coupled to an input force, F, by a slideable interface 2, providing a slideable interface that traverses around the length of the spiral 3. Any slideable interface 2 is anticipated such as a slideable bearing bordering two sides of a solid spiral 3, a bearing completely encircling the spiral 3, and a pivot pin within a spiral cut groove, etc. In some embodiments, a the slideable interface 2 includes a bearing or is made of a slippery material, or both such as a nylon bushing rotatably mounted on a smooth shaft such that the nylon bushing slides through the spiral cut groove and the nylon bushing also rotates freely on the smooth shaft. Although a tubular shaped bushing is anticipated, any other shape is equally anticipated as long as the bushing slides within the groove of the spiral 3.

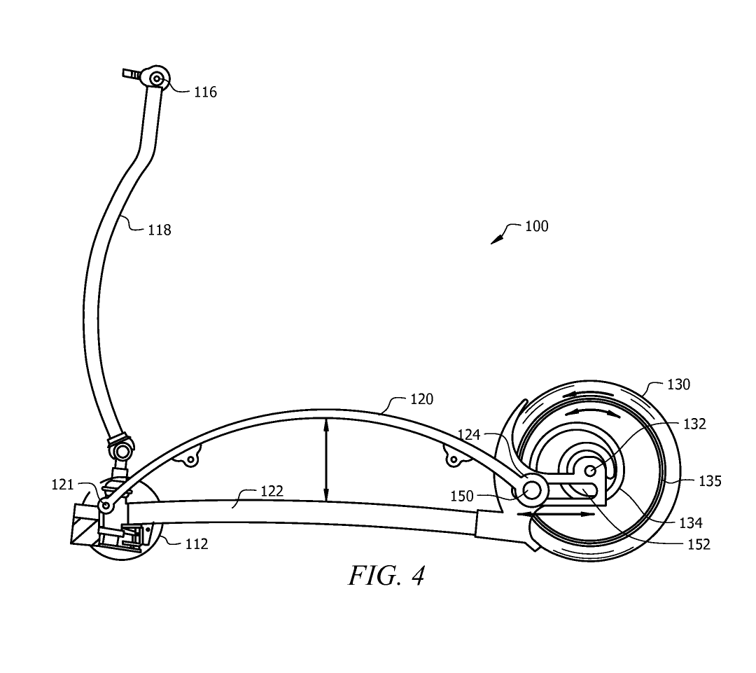

Note that the force, F, is directional or reciprocating, and, although not required, the force, F, is preferably directed in a substantially linear direction. In such, if the force, F, is not directed in a linear direction, it is anticipated that such a force, F, be channeled into a linear direction as, for example, by a channel 152 (see FIG. 4).

As a positive force, F, is applied to the interface 2. The interface 2 is caused to travel around the spiral 3. By restricting the force moment, as the positive force, F, is applied, the spiral 3 is cause to rotate in a counterclockwise rotational direction per the spiral 3 shown in FIGS. 1A-1C, noting that if the spiral 3 is inverted, the positive force, F, will cause the spiral 3 to rotate in a clockwise direction.

In the examples of FIGS. 1A-1C, as force, F, is applied to the interface 2, the spiral 3 (and anything coupled to the spiral 3) rotates in a counterclockwise direction as indicated by the rotation of the spiral 3 in FIG. 1B, and further rotation as in FIG. 1C. As a negative force, F, is then applied, the spiral 3 reverses direction, in this example, rotating in a clockwise rotational direction.

Any shape and form of spiral 3 is anticipated to provide specific force conversions and distance/rotational distance conversions. For example, a tighter spiral 3 (e.g. more windings around the pivot 5) produces a greater rotational distance for the same amount of linear movement of the interface 2.

In some embodiments, the radii of the spiral decreases in a linear fashion. For example, in the spiral 3 shown in FIGS. 1A-1C, the radius of the spiral 3 is greatest at the outer end of the spiral 3 and the radius decreases by a fixed percentage for every fixed number of degrees around the spiral 3.

In some embodiments, for certain applications, the rate of change of the radius of the arc is not necessarily linear. In that, to compensate for certain energy sources such as springs, pistons, etc., the rate of change of the radii of the spiral 3 is set to compensate for power curves of the energy source. An example of such has the outer windings of the spiral 3 has looser windings on the outside and tighter windings on the inside or vice versa. It is also anticipated that the rate of change varies throughout the spiral 3 at any rate of change needed.

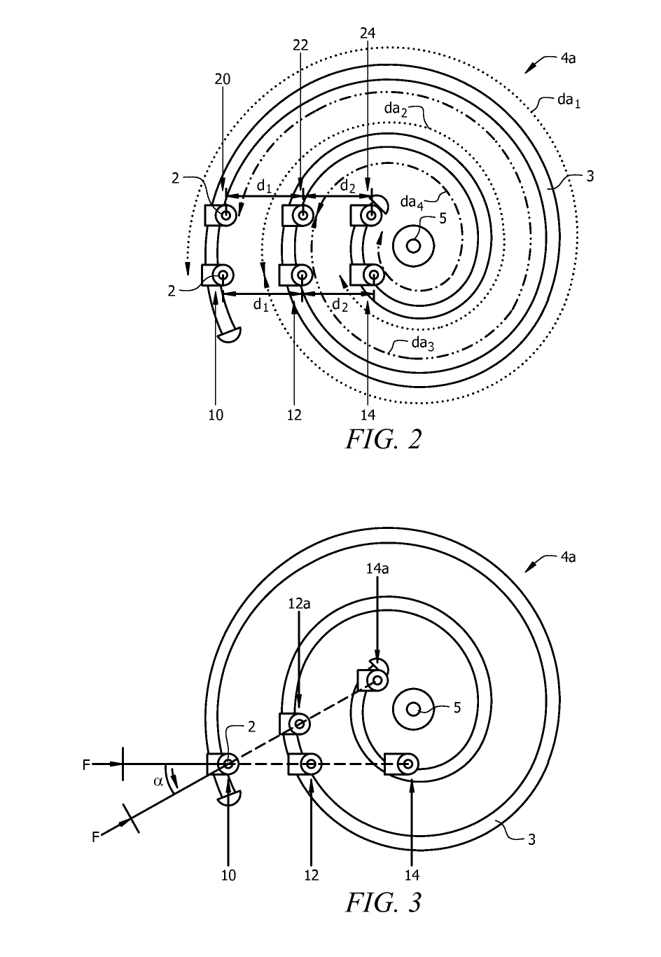

Referring to FIG. 2, a schematic view of a spiral gearing system 4a showing distances traveled through several position of the interface 2 within the spiral 3 is shown. In this example, the interface 2 is shown in two different starting locations depicted as position 10 (first starting location) and position 20 (second starting location). Starting with the interface 2 in the first starting position 10, a force applied to interface 2 inward of the spiral 3 will result in the spiral 3 rotating in a counterclockwise rotation. In such, if the force is sufficient to move the interface 2 from the original position 10 to the second position 12, a linear displacement of distance d₁ is made. Consequently, the spiral will have rotated in counterclockwise a rotational distance da₁. If the force continues to move the interface 2 from the second position 12 to the third position 14, a linear displacement of distance d₂ is made. Consequently, the spiral will have rotated in counterclockwise a second rotational distance da₂. Note that the average radius of the spiral 3 for the first rotational distance da₁ is greater than the average radius of the spiral 3 for the second rotational distance da₂. Therefore, since the circumference of each section is proportional to the average radius of the spiral 3, the first rotational distance da₁ is greater than the second rotational distance da₁. Therefore, assuming distance d₁ is the same as distance d₂, the interface 2 must travel further around the spiral from the first position 10 to the second position 12 as compared to travel from the second position 12 to the third position 14. This results in a different force/speed curve between the first distance of travel d₁ and the second distance of travel d₂. For example, if the force, F, provides a constant velocity from the first position 10 to the third position 14, the spiral 3 will rotate faster during d₁ and slower during d₂.

In this example, the spiral 3 is designed so that a first distance of movement d₁ of the interface 2 rotates the spiral 3 the same number of degrees (e.g. approximately 360 degrees) as the second distance of movement d₂ (approximately 360 degrees). If the spiral 3 is designed so that the inner portion is wound tighter than the outer portion, then the second distance of movement d2 will rotate the spiral 3 more than one rotation (e.g. greater than 360 degrees). If the spiral 3 is designed so that the inner portion is wound looser than the outer portion, the opposite ratios occur.

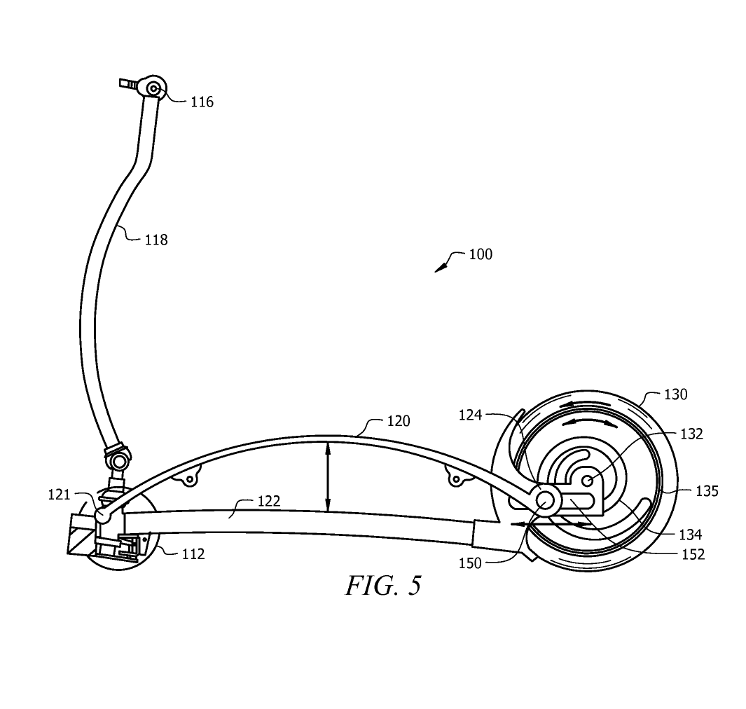

This structure is useful for certain sources of movement such as a spring, as in the scooter example of FIGS. 4-6, where a greater ratio of linear distance to rotation is desired as the spring flattens out, in which the inner rings of the spiral 3 is wound tighter than the outer rings of the spiral 3. Similarly, with a combustion cylinder, when the combustion occurs and the cylinder head begins to move, move force/power is available than when the cylinder approaches the end of travel.

The force/speed ratios are adjustable, depending upon the starting position within the spiral 3. For example, if the interface 2 is physically moved to a starting location closer to the center of the spiral 3, such as the fourth position 20, then first rotation distance da₃ (circumference) is less than rotational distance da₁ and the second rotation distance da₄ is less than the rotation distance da₁. This results in a slower overall rotation of the spiral 3 (and anything coupled to the spiral 3) but a higher torque. Such is useful, for example, in a device of human conveyance in which greater speed is desired on level surfaces (the first set of positions 10/12/14) and greater torque is desired when ascending a slope (the second set of positions 20/22/24)

Referring to FIG. 3, a schematic view of a spiral gearing system 4a showing changes in the gearing ratio caused by changes in force angle, a, is shown. In this, the first set of positions 10/12/14 are similar to the first set of positions 10/12/14 in FIG. 2, resulting in the same distance and force ratios as the first set of positions 10/12/14 of FIG. 2. Now, by changing the angle, α, the first position 10 remains constant, but the new second position 12a is rotationally further along the spiral than old second position 12 and, hence, the spiral 3 will rotate more when the angle, α, is changed then before the angle, a, is changed. Likewise, the new third position 14a is rotationally further along the spiral than old second position 14. This is a second way to adjust the speed/force ratios of the spiral gear by changing the angle of the force, F.

Referring to FIGS. 4 through 6, operational schematic views of an example of a spiral gearing system are shown. To demonstrate one embodiment of the spiral gearing system, a scooter 100 is shown. The scooter 100 has a bowed spring 120 that is anchored to a frame 122 at one end 121 and interfaced to the spiral 134 at a distal second end 124. The frame rotatably supports a front wheel 112 and a rear wheel 130 as, preferably, a constant distance apart. At the distal end of the bowed spring 120 is the interface 150. The interface 150 has a pin or bearing that travels within the groove of the spiral 134. In this example, the interface 150 is forced to move in a linear direction by a channel 152. The spiral 134 is cut in a disc 135 that rotates in both directions as the interface 150 moves back and forth, but the disc 135 is interfaced to the rear wheel 130 through a ratchet, for example within the hub 132, thereby enabling a forward motion of the scooter 100 during downward pressure of the bow spring 120 but not drawing the scooter 100 rearward upon upward movement (release) of the bow spring 120.

Initially, the spring 120 is in the relaxed configuration as shown in FIG. 4. No rider/user is shown for brevity reasons. The bow spring 120 is anticipated to be bent by the force of a rider/user's weight pushing down on the bow spring 120, typically by stepping on the bow spring 120.

Although described in detail relating to a scooter 100, the spiral gear system is useful for many purposes and it not limited to any particular use. The example of a scooter 100 is provided to show one exemplary use for the spiral gear system.

The spiral gear system as disclosed is useful and adaptable to any system in need of a conversion from a linear, reciprocating motion, into a rotational motion.

Throughout this description, the term “forward rotation” refers to a rotation of a wheel 112/130 or other component 134/135 which results in a forward movement of the scooter (e.g. forward rotation of the rear wheel when viewed from the left side of the scooter is counter clockwise). Similarly, “rearward rotation” refers to a rotation of a component 134/135 of the scooter which, if coupled to the wheel 112/130, would result in a rearward movement of the scooter (e.g. rearward rotation of the spiral channel 134 when viewed from the left side of the scooter is clockwise).

For completeness, the device of human conveyance shown in FIGS. 4-6 is a scooter having a handle 116, handle riser 118, one or more front wheels 112, one or more rear wheels 130, and a stationary frame member 122. The stationary frame member 122 typically holds the front wheel(s) 112 at a fixed distance from the rear wheel(s) 130.

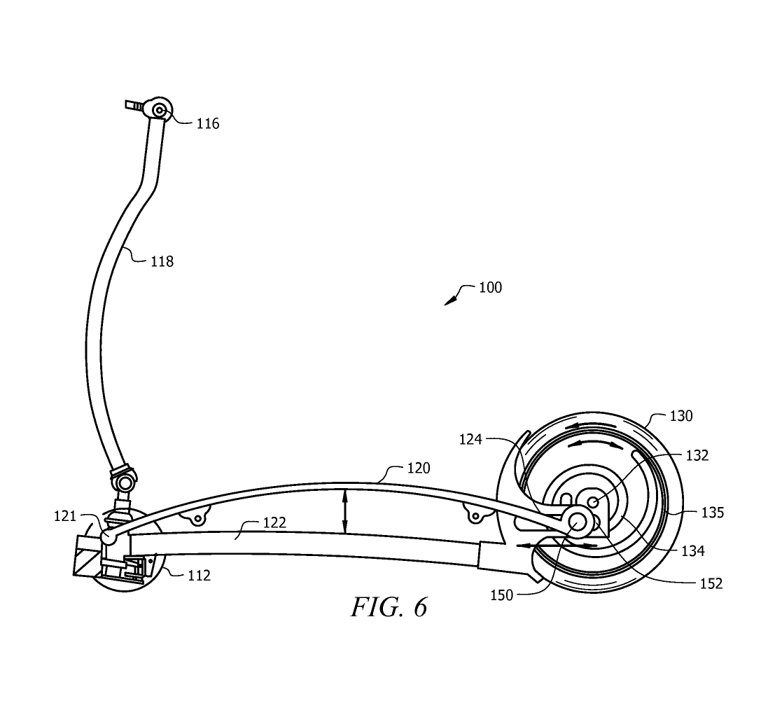

FIGS. 4-6 show three phases of a basically transition of the bow spring 120 from a relaxed position (as in FIG. 4) in which no downward force is applied to the bow spring 120 to a compressed/flattened position (as in FIG. 6) in which downward force applied to the bow spring 120 has substantially flattened the bow spring 120. Being that the forward end 121 of the bow spring 120 is affixed to the scooter near where the front wheel 112 and the front of the stationary frame member 122 meet, as the bow spring 120 is compressed/flattened, the tail portion 124 of the bow spring 120 moves rearward, in the direction of the rear wheel 130.

In general, the tail portion 124 changes distance from the anchor point 121 responsive to the bending of the bow spring 120, but typically in a non-linear distance and force. For example, in one embodiment, the 1st inch of deflection of the bow spring 120 results in ¾″ movement of the tail portion 124. The 2nd inch of deflection of the bow spring 120 results in ⅝″ movement of the tail portion 124. The 3rd inch of deflection of the bow spring 120 results in ½″ movement of the tail portion 124. Without a variable gear ratio, the non-linear distance travel of the tail portion 124 will, in effect, provide a decreasing gear ratio throughout the bow spring's 120 deflection at the rear wheel 130.

The rearward motion is focused by a linear channel 152 and applied to a interface 150, pushing the interface 150 against an inner wall of a spiral channel 134. A protrusion or bearing of the interface 150 travels with the spiral channel 134 which is, for example, formed in a hub 135. As the spring 120 is compressed, the interface 150 exerts a force against the inner wall of the spiral channel 134 and, resultantly, the interface forces rotation of the spiral channel 134 (and the hub 135). This results in the spiral channel 134 and hub 135 rotating in the forward direction as the spring 120 is compressed, due to the interface 150 moving along the channel 152 and applying tangential force against the inner wall of the spiral channel 134. Being that there is a decreasing radius of the spiral channel 134, force curves and movement ratios are determined by the instantaneous location of the interface 150 within the channel 134. In a preferred embodiment related to the scooter 100, the force curves and movement ratios change as the spiral channel 134 rotates responsive to the force of the interface 150 to compensate for the variations in the force curve of the spring 120. The relationship between distance of movement of the peg interface and degrees of rotation of the spiral channel 134 (and hub 135 and wheel 130) relates to the instantaneous radius of the spiral channel 134 at the location of the interface 150. Being that the radius of the channel 134 is smaller towards the end of travel of the interface 150 through the spiral channel 134, the relationship between distance of movement of the interface 150 and degrees of rotation of the spiral channel 134 changes throughout the travel of the interface 150 through the spiral channel 134. For example, at the beginning of travel of the interface 150 in the spiral channel 134 (e.g. as shown in FIG. 4), a first inch of linear motion of the interface 150 results in 270 degrees of rotation of the spiral channel 134 and hub 135. The second inch of linear motion of the interface 150 results in less rotation of the spiral channel 134 and hub 135, for example, 225 degrees of rotation. The third inch of linear motion of the interface 150 results in even less rotation of the spiral channel 134 and hub 135, for example, 180 degrees of rotation. This is just one example and the ratio is predetermined by the overall shape of the spiral channel 134 (e.g. the spiral channel 134 is anticipated to be of any shape and with any desired set of instantaneous radii, along each point of the spiral channel 134, thereby permitting a wide range of force and gearing ratios).

The force and gearing ratio is also dependent upon the initial location of the interface 150 with respect to the spiral channel 134. As shown in FIGS. 4-6, the interface 150 is held by the linear channel 152. Though shown as a linear channel 152, any form of channel 152 is anticipated, including non-linear. The location of the interface 150 with respect to the spiral channel 134 determines the starting point within the spiral channel 134 and, hence, the set of speed and force ratios between the bow spring 120 and the rotation of the rear when 130. As in FIGS. 4-6, if the channel 152 is lifted, the starting point of the interface 150 within the channel 134 changes, thereby changing the speed and force ratios. Therefore, by continuously adjusting the vertical location of the linear channel 152 with respect to the spiral channel 134, the force and gearing ratio is adjustable and, in some embodiments, this adjustment is available to the user as a way to modify the force and gearing ratio during use to compensate, for example, for the weight of the user, the level of terrain, desired acceleration and maximum speed, etc.

When the user lifts, the bow spring 120 relaxes and restores to an original, bent shape and the interface 150 is pulled along the channel 152 (towards the front wheel[s] 112), forcing the interface 150 to travel in a reverse direction through the spiral channel 134. This results in the spiral channel 134 and hub 135 rotating rearward (clockwise) as the spring 120 is relaxed. Therefore, in this application, it is envisioned that the spiral channel 134 and hub 135 are interfaced to the rear wheel 130 by a ratchet or one-way bearing 132, or any device that couples the rotational movement in one direction of the spiral 134 and hub 135 to the rear wheel 130 (forward) while decoupling the rotational movement in one direction of the spiral 134 to the rear wheel 130 in the other direction (rearward). This results in the rear wheel 130 turning in a forward rotation when the spiral channel 134 and hub 135 rotates in a forward rotation due to the rearward pressure of the interface 150 against the spiral 134. The forward rotation of the rear wheel 130 moves the scooter in the forward direction when the rear wheel 130 of the scooter is resting on a surface.

Any type of ratchet or one-way bearing 132 that has an active direction in which rotation in one direction of a shaft translates into rotation in that same direction of a hub around the shaft is anticipated.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A spiral gear system comprising:
a source of reciprocating motion;
a spiral rotatably held to enable rotation of the spiral; and
an interface coupling the source of reciprocating motion to the spiral such that motion of the source of reciprocating motion in a first direction causes the interface to traverse the spiral in one direction and, therefore, causes the spiral to rotate in a first rotational direction, and motion of the source of reciprocating motion in a second direction, opposite to the first direction, causes the interface to traverse the spiral in a direction opposite of the one direction and, therefore, causes the spiral to rotate in a second rotational direction opposite of the first rotational direction.

2. The spiral gear system of claim 1, wherein the spiral is rotatably held by a pivot to enable rotation of the spiral.

3. The spiral gear system of claim 1, wherein the spiral is held to a shaft, and the shaft is rotatably held by a bearing to enable rotation of the spiral.

4. The spiral gear system of claim 1, wherein the spiral is interfaced to a shaft through a one-way bearing, and the shaft is rotatably held by a bearing to enable rotation of the spiral, thereby the shaft is caused to rotate in the first rotational direction but is not cause to rotate in the second rotational direction.

5. The spiral gear system of claim 1, wherein the spiral is a spiral groove cut into a disc and the interface coupling the source of reciprocating motion to the spiral is a pin that travels within the spiral groove.

6. The spiral gear system of claim 5, wherein the pin has a bearing to reduce friction between the spiral groove and the peg.

7. The spiral gear system of claim 1, wherein a ratio between a distance of movement of the source of reciprocating movement and a degree of rotation of the spiral is adjusted by changing an angle between the source of reciprocating movement and a tangent of the spiral.

8. The spiral gear system of claim 1, wherein a ratio between a distance of movement of the source of reciprocating movement and a degree of rotation of the spiral is adjusted by changing a point at which the interface starts with respect to the spiral.

9. A spiral gear system comprising:
an interface, the interface for receiving reciprocating motion;
a disc mounted to a rotatable shaft by a one-way bearing; and
a spiral groove having a width suitable for slideably holding the interface such that the interface will move along the spiral groove;
whereas a linear movement of the interface in a first direction causes the interface to traverse the spiral groove in one direction and, therefore, causes the spiral groove, disc, and shaft to rotate in a first rotational direction, and linear movement of the interface in a second direction, opposite to the first direction, causes the interface to traverse the spiral in a direction opposite of the one direction and, therefore, causes the spiral groove and disc to rotate in a second rotational direction opposite of the first rotational direction.

10. The spiral gear system of claim 9, wherein the shaft is interfaced to a wheel.

11. The spiral gear system of claim 9, wherein the interface is a bearing.

12. The spiral gear system of claim 9, wherein the interface is a metal peg having a plastic bushing mounted thereto.

13. The spiral gear system of claim 9, wherein the spiral is a solid metal spiral and the interface is a bearing slideably interfaced to opposing sides of the solid metal spiral.

14. The spiral gear system of claim 9, wherein a ratio between a distance of movement of the source of reciprocating movement and a degree of rotation of the spiral groove is adjusted by changing an angle of the source of reciprocating movement with respect to the spiral groove.

15. The spiral gear system of claim 9, wherein a ratio between a distance of movement of the source of reciprocating movement and a degree of rotation of the spiral groove is adjusted by changing a point at which the interface starts within the spiral groove.

16. A method of converting reciprocating movement into rotational movement, the method comprising:
providing a source of reciprocating motion;
providing a spiral rotatably held to enable rotation of the spiral;
coupling the source of reciprocating motion to the spiral through an interface, the interface being coupled to the spiral such that the interface freely traverses the spiral;
the source of reciprocating motion moving the interface in a first direction, thereby forcing the interface to traverse the spiral in one direction and, therefore, the spiral rotates in a first rotational direction; and
the source of reciprocating motion moving the interface in a second direction, opposite to the first direction, thereby forcing the interface to traverse the spiral in a direction opposite of the one direction and, therefore, the spiral rotates in a second rotational direction opposite of the first rotational direction.

17. The method of claim 16, wherein the spiral is a groove cut in a disc and the disc is rotatably coupled to a rotatable shaft such that, as the spiral rotates in either the first rotational direction or the second rotational direction, so does the shaft.

18. The method of claim 16, wherein the spiral is a groove cut in a disc and the disc is rotatably coupled to a rotatable shaft by a one-way bearing such that, as the spiral rotates in the first rotational direction, so does the shaft but when the spiral rotates in the second rotational direction, the shaft is decoupled from the spiral.

19. The method of claim 18, wherein the one-way bearing is a ratchet.

20. The method of claim 16, wherein the source of reciprocating motion is a piston.
